(19) United States
(12) Patent Application Publication
(10) Pub. No.: US 2017/0238486 A1
(43) Pub. Date: Aug. 24, 2017

(54) BIODEGRADABLE NET POTS FOR HYDROPONIC APPLICATIONS

(71) Applicants: Eric De Feo, San Francisco, CA (US); Gabrielle Pettinelli, San Francisco, CA (US)

(72) Inventors: Eric De Feo, San Francisco, CA (US); Gabrielle Pettinelli, San Francisco, CA (US)

(21) Appl. No.: 15/436,999

(22) Filed: Feb. 20, 2017

Related U.S. Application Data
(60) Provisional application No. 62/297,367, filed on Feb. 19, 2016.

(51) Int. Cl. A01G 31/02

(52) U.S. Cl. CPC A01G 31/02

(57) ABSTRACT

An improved hydroponic net pot includes a layer of filter material enabling moisture and nutrients to enter into the growth media, while preventing the growth media and debris from entering into the hydroponic vessel. The pot and the filter are both preferably constructed of biodegradable, compostable materials. The pot may include a non-zero shoulder allowing the pot to be inserted into vessels with vertical walls or upright, slanted walls of vertical vessels. A removable cover may be provided over the opening of the pot, enabling the article to be shipped with growth media, with or without seeds or plant material.

### REFERENCE TO RELATED APPLICATIONS

This invention claims priority to U.S. Provisional Patent Application Ser. No. 62/297,367, filed Feb. 19, 2016, the entire content of which is incorporated herein by reference.

### FIELD OF THE INVENTION

This invention relates generally to hydroponics and, in particular, to a biodegradable net pot for hydroponic applications.

### BACKGROUND OF THE INVENTION

Living plants improve space aesthetically, improve air quality, and are therefore particularly desirable in occupied living spaces. In recent years, there has been a surge in the number of people who wish to grow their own food, especially in environments where the task was once daunting—such as indoor or in city spaces. So-called “food deserts,” areas where little fresh food is easily accessible, have become prevalent in cities around the world where residents tend to consume processed, packaged, or canned food with depleted nutrients.

There is accordingly a need for system and/or method that enables a person to grow a large assortment of plants for a variety of purposes in a hydroponic environment without taking up too much space or using up their window sources for natural sunlight. Also, many urban dwellings have limited to little or no window space, which makes growing one's own food difficult. Growing plants for consumption provides cost savings on impending surges in food prices. Additionally, the cultivation of plants has been proven to foster a healthy lifestyle through dietary and therapeutic benefits.

Many people find the task of watering plants on a schedule to be overwhelming. People tend to either overwater or underwater their vegetation that results in plant loss. A significant amount of time and energy is required to support plant life, which can incorporate watering, weeding, pruning etc. In the past, both aeroponic and hydroponic systems have been tested. Hydroponics is said to provide healthier plants that grow faster than those grown in soil. Although hydroponic proves to deliver maximum nutrition to plant roots in addition to proper aeration, in the absence of a soil substitute larger systems are required to house these structures. Additionally, some hydroponic methods do not allow optimal ventilation for the root system.

Pending U.S. patent application Ser. No. 14/935,927, the entire content of which is incorporated herein by reference, addresses deficiencies of the prior art with respect to hydroponic growing. The invention described in this pending '927 Application is essentially a hybrid of hydroponic and aeroponic technologies that allows plants to grow optimally, but in a smaller system using a spraying technology. A plurality of plants arranged in a growing structure are illuminated using “near-sunlight” conditions to enhance their growth potential, and thereby, maximize plant production per unit area or per unit volume.

The system includes a vessel with an outer wall having a plurality of holes, each adapted to receive a “net pot” (also called net cups, net pods and plant baskets). The net pots ensure that root portions are within the interior of the vessel and the foliage portions extend away from the outer wall of the vessel. Unique to the design, the outer wall(s) of the vessel are slanted or sloped, enabling the plant foliage to be offset from top to bottom, allowing all plants to receive an adequate amount of light from an upper source. The system may further include a pump and a liquid conduit to transport a nutrient-rich aerated aqueous solution vertically upwards to feed the net pots, one or more operational timers, and an optional trellis arrangement.

Net pots are common in the hydroponic industry. Existing net pots are essentially plastic baskets that hold a growing plant in the substrate material while allowing nutrient infused water to pass through and reach the root systems. However, there are several problems with available net pots. For one, the perforated baskets have large voids that allow substrate material and debris to pass through to the motor or filter, which contributes to clogging of the hydroponic system. Second, existing net pots are made of non-biodegradable plastic, and remain in landfills when discarded. Third, although the pots typically have shoulders to keep them from falling into the watering vessel, these shoulders are parallel to the rim of the pot such that existing net pots cannot be installed at an angle.

### SUMMARY OF THE INVENTION

This invention resides in an improved net pot for hydroponic applications. Overall, the net pot is a cup-shaped article having an upper portion and a lower portion with a bottom. The upper portion of the article includes a solid wall surrounding an opening with a peripheral rim enabling the article to be filled with plant growth media. The lower portion of the article includes a perforated wall with a cross section enabling the lower portion of the article to be inserted into an aperture in a wall of a hydroponic vessel. The article further includes a shoulder portion between the upper portion and the lower portion, the shoulder portion being physically configured to prevent the article from extending into the hydroponic vessel past the shoulder portion.

The preferred embodiments include a layer of filter material, covering the lower portion of the article, enabling moisture and nutrients to enter into the growth media, while preventing the growth media and debris from entering into the hydroponic vessel. The layer of filter material may be integrally formed with the cup-shaped article. Alternatively, the layer of filter material may be separate and insertable into the cup-shaped article. Regardless, the article and the filter material are both preferably constructed of biodegradable, compostable materials.

The rim of the opening defines a plane and, according to one preferred embodiment, the shoulder portion is at a non-zero angle relative to the plane. This allows the article to be inserted into hydroponic vessels with vertical walls or upright, slanted walls of vertical vessels. The upper and lower portions may include flat sides, such that the cup-shaped article resembles a truncated pyramid, and the perforations may be elongated perforations oriented from the upper portion to the bottom of the lower portion. A removable cover may be provided over the opening, enabling the cup-shaped article to be shipped with growth media, with or without seeds or plant material.

### BRIEF DESCRIPTION OF THE DRAWINGS

FIG. 1 is an oblique view of a preferred embodiment of the invention;

FIG. 2 is a bottom view of the embodiment of FIG. 1;

FIG. 3 is a solid model showing the pot filled with growth media;

FIG. 4 depicts possible filter possibilities;

FIG. 5 depicts other filter possibilities;

FIG. 6, is a top view of a net pot according to the invention;

FIG. 7 is a side view of the embodiment of FIG. 6;

FIG. 8 is a front view;

FIG. 9 is a top view; and

FIG. 10 is a back view.

### DETAILED DESCRIPTION OF THE PREFERRED EMBODIMENTS

This invention resides in an improved net pot, particularly suited to hydroponic applications. In the preferred embodiments the net pot is a molded, cup-shaped article, including the use of injection molding processes. Other advantages include the use of a filter mesh to contain debris from clogging filters, as well as the ability to transplant the net pots directly to another medium ground. Nutrients such as fertilizers may be added to the plastic material such that when the pod decomposes, the nutrient content can feed soil.

In one embodiment, the article has a pre-formed biomesh filter wherein the mesh is adhered to the net pot via an overmold manufacturing process. In an alternative embodiment, the article includes a separate removable/replaceable filter that functions as a plant ‘coffee-pod’ of sorts that may be used in conjunction with most if not all hydroponic systems.

Due to the nature of the material and molding process, the design can manifest any net pot shape found on the market, including those described in U.S. patent application Ser. No. 14/935,927. Either version can be sold as a standalone product, or can be pre-filled with soil or soil plus seed(s) and covered with a lid 112, similar to a single cup coffee machine pod.

In all of the embodiments disclosed herein the structures prohibit substrate from passing through the net pot and into the supporting structure or vessel. The preferred material for the entire product (both body and filter) is a compostable resin, though the same process could easily be utilize for conventional plastic types as well. Biodegradable plastics and additives are now available from a wide variety of sources including, for example, ENSO Plastics of Mesa, Ariz.

FIG. 1 is an oblique view of a preferred embodiment. The article comprises an upper portion 102 with solid walls, which may include decorative outer surfaces and a cosmetic finish, and a lower portion 104 with apertures enabling water and nutrients to flow therethrough. The apertures may be elongated apertures formed with vents 110 and ribs 111 as depicted in the diagrams.

The design includes a shoulder portion 108 between the upper and lower portions to prevent the article from falling into the hydroponic vessel or growth chamber. A shoulder portion 108 indicates the interface to the hydroponic growth chamber, with the permeable lower portion being exposed to water and nutrients and the upper portion extending outwardly from the wall of the vessel. In accordance with one preferred embodiment, the shoulder portion 108 comprises a diagonal lip 108, enabling the lower portion of the article to be inserted into hydroponic vessels with vertical walls or upright, slanted walls of vertical vessels, including those described in the '927 Application referenced herein.

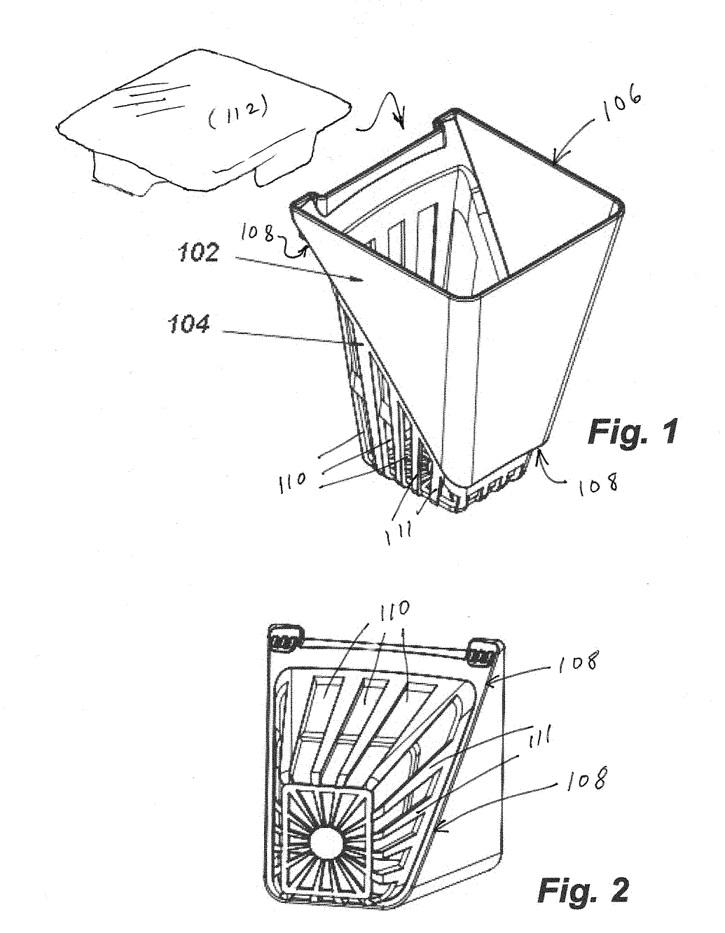

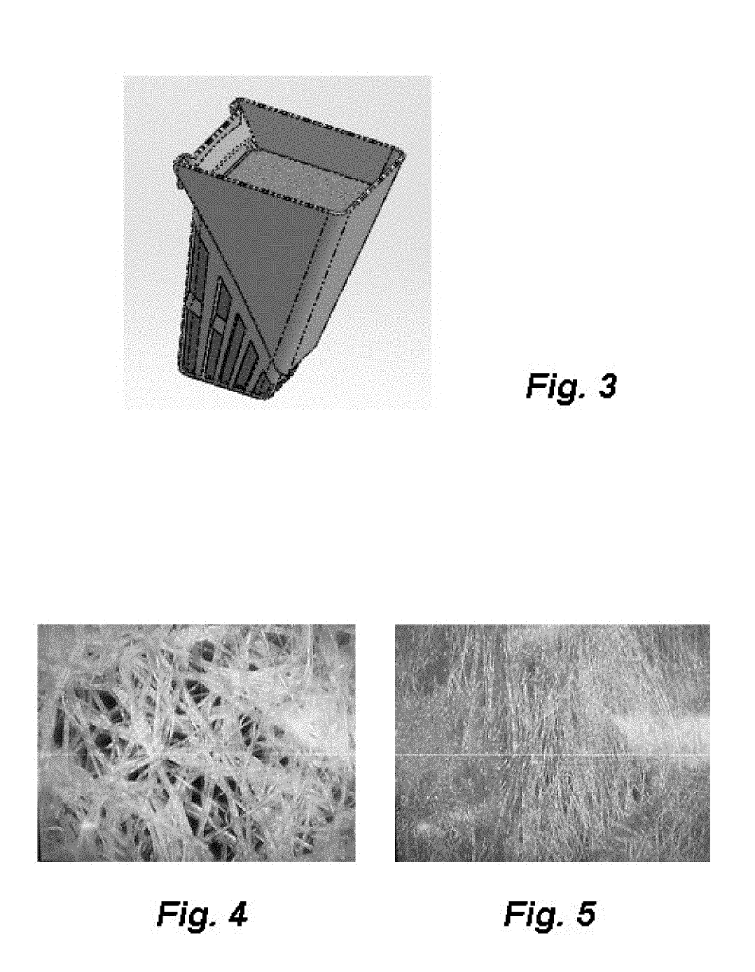

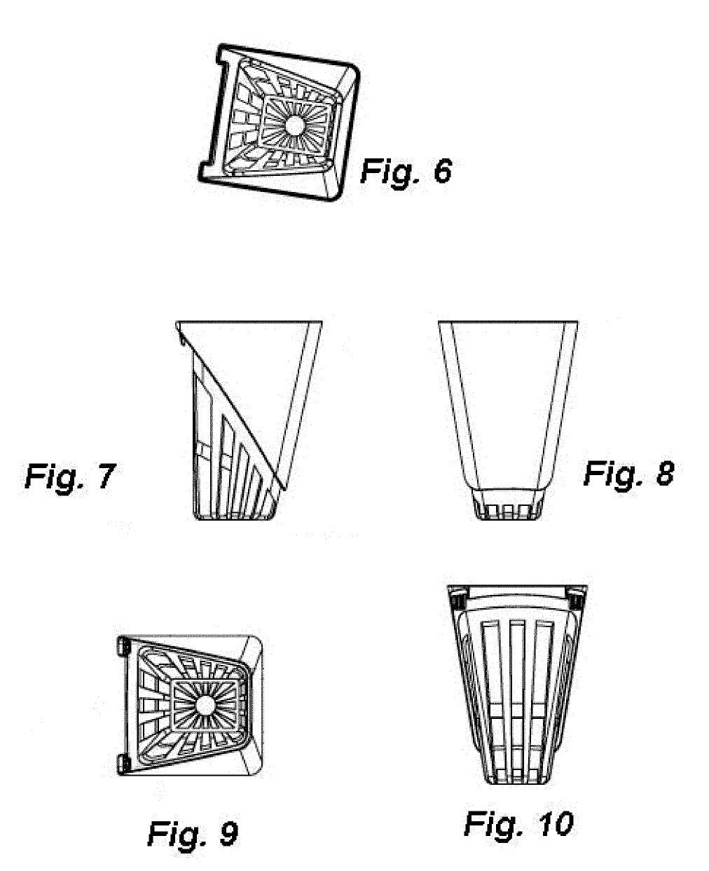

FIG. 2 is a bottom view of the article, and FIG. 3 is a solid model showing the pot filled with growth media. FIG. 6, is a top view, FIG. 7 a side view, FIG. 8 a front view, FIG. 9 a top view, and FIG. 10 a back view. Many different exact dimensions are possible, with the article overall being generally a few inches tall and a few inches wide.

FIGS. 4, 5 show two of many possible filter possibilities. The preferred material is a spun bond web produced from a renewable biopolymer, polylactic acid (PLA). In all cases the material is renewable, compostable, and biodegradable. Prototype A (FIG. 4): Mesh density=180-200 g/m̂2, Pore size =0.10 mm̂2 max à This material can be thermal formed. Prototype B (FIG. 5): Mesh density=15-20 g/m̂2, Pore size=0.05 mm̂2 max à. This material may only work in a die cutting application.

1. A net pot for hydroponic applications, comprising:
a cup-shaped article having an upper portion and a lower portion with a bottom;
wherein the upper portion of the article includes a solid wall surrounding an opening with a peripheral rim enabling the article to be filled with plant growth media;
wherein the lower portion of the article includes a perforated wall with a cross section enabling the lower portion of the article to be inserted into an aperture in a wall of a hydroponic vessel;
the article further including a shoulder portion between the upper portion and the lower portion, the shoulder portion being physically configured to prevent the article from extending into the hydroponic vessel past the shoulder portion;
further including a layer of filter material covering the lower portion of the article, the filter material enabling moisture and nutrients to enter into the growth media while preventing the growth media and debris from entering into the hydroponic vessel; and
wherein the article and the filter material are both constructed of biodegradable, compostable materials.

2. The net pot of claim 1, wherein the layer of filter material is integrally formed with the cup-shaped article.

3. The net pot of claim 1, wherein the layer of filter material is separate and insertable into the cup-shaped article.

4. The net pot of claim 1, wherein the rim of the opening defines a plane and the shoulder portion is at a non-zero angle relative to the plane.

5. The net pot of claim 1, wherein the upper and lower portions have flat sides such that the cup-shaped article resembles a truncated pyramid.

6. The net pot of claim 1, including elongated perforations oriented from the upper portion to the bottom of the lower portion.

7. The net pot of claim 1, further including a removable cover over the opening enabling the cup-shaped article to be provided with growth media, with or without seeds or plant material.

8. A net pot for hydroponic applications, comprising:
a cup-shaped article having an upper portion and a lower portion with a bottom;
wherein the upper portion of the article includes a solid wall surrounding an opening with a peripheral rim enabling the article to be filled with plant growth media;
wherein the lower portion of the article includes a perforated wall with a cross section enabling the lower portion of the article to be inserted into an aperture in a wall of a hydroponic vessel;
the article further including a shoulder portion between the upper portion and the lower portion, the shoulder portion being physically configured to prevent the article from extending into the hydroponic vessel past the shoulder portion;
wherein the rim of the opening defines a plane; and
the shoulder portion is at a non-zero angle relative to the plane of the rim.

9. The net pot of claim 8, further including a layer of filter material covering the lower portion of the article, the filter material enabling moisture and nutrients to enter into the growth media while preventing the growth media and debris from entering into the hydroponic vessel.

10. The net pot of claim 9, wherein the layer of filter material is integrally formed with the cup-shaped article.

11. The net pot of claim 9, wherein the layer of filter material is separate and insertable into the cup-shaped article.

12. The net pot of claim 9, further including a removable cover over the opening enabling the cup-shaped article to be provided with growth media, with or without seeds or plant material.

13. The net pot of claim 8, wherein the upper and lower portions have flat sides such that the cup-shaped article resembles a truncated pyramid.

14. The net pot of claim 8, including elongated perforations oriented from the upper portion to the bottom of the lower portion.

15. A net pot for hydroponic applications, comprising:
a cup-shaped article having an upper portion and a lower portion with a bottom;
wherein the upper portion of the article includes a solid wall surrounding an opening with a peripheral rim enabling the article to be filled with plant growth media;
wherein the lower portion of the article includes a perforated wall with a cross section enabling the lower portion of the article to be inserted into an aperture in a wall of a hydroponic vessel;
wherein the upper and lower portions have flat sides such that the cup-shaped article resembles a truncated pyramid; and
including elongated perforations oriented from the upper portion to the bottom of the lower portion.

16. The net pot of claim 15, further including a layer of filter material covering the lower portion of the article, the filter material enabling moisture and nutrients to enter into the growth media while preventing the growth media and debris from entering into the hydroponic vessel.

17. The net pot of claim 16, wherein the layer of filter material is integrally formed with the cup-shaped article.

18. The net pot of claim 16, wherein the layer of filter material is separate and insertable into the cup-shaped article.

19. The net pot of claim 16, further including a removable cover over the opening enabling the cup-shaped article to be provided with growth media, with or without seeds or plant material.

20. The net pot of claim 15, including a shoulder portion between the upper portion and the lower portion, the shoulder portion being physically configured to prevent the article from extending into the hydroponic vessel past the shoulder portion; and
wherein the shoulder portion is at a non-zero angle relative to a plane defined by the rim of the opening into the cup-shaped article.
